(19) United States
(12) Patent Application Publication
(10) Pub. No.: US 2013/0290874 A1
(43) Pub. Date: Oct. 31, 2013

(54) PROGRAMMATICALLY ADJUSTING A DISPLAY CHARACTERISTIC OF COLLABORATION CONTENT BASED ON A PRESENTATION RULE

(71) Applicants: Kar-Han TAN, Sunnyvale, CA (US); Ian N. Robinson, Pebble Beach, CA (US)

(72) Inventors: Kar-Han TAN, Sunnyvale, CA (US); Ian N. Robinson, Pebble Beach, CA (US)

(21) Appl. No.: 13/457,933

(22) Filed: Apr. 27, 2012

(51) Int. Cl. G06F 3/01; G06F 15/16

(52) U.S. Cl. 715/756

(57) ABSTRACT

A video collaboration session is provided in which data corresponding to a collaboration content is processed. The collaboration content includes a video component of a participant relative to a collaboration medium, as well as a medium content component. During the video collaboration session, one or more display characteristics of the video component and/or medium content component are programmatically adjusted, based on one or more presentation rules that relate to how the video component is to appear relative to at least the portion of the medium content component.

### BACKGROUND

Collaboration systems use computing environments to enable participants of a collaboration session to share content with one another. Some collaboration systems record video, typically of one collaborator or the collaborator's medium, for sharing with the collaboration medium of the other participant. In addition, the collaboration systems can enable participants to share media, such as documents, with one another. This can result in a participant viewing media and video at the same time on a given collaboration medium (e.g., computer screen).

### BRIEF DESCRIPTION OF THE DRAWINGS

FIG. 1 illustrates an example system for implementing a video collaboration session, according to one or more embodiments.

FIG. 2 illustrates an example method for implementing a video collaboration session, according to one or more embodiments.

FIG. 3 illustrates an example of a collaboration session, implemented using one or more embodiments such as described with FIG. 1 or FIG. 2.

FIG. 4A through FIG. 4C illustrate examples of dynamic adjustments that can be made to the display characteristics of collaboration content, according to one or more embodiments.

FIG. 5 illustrates an example computing system which can be implemented with or as part of a collaboration system, according to one or more embodiments.

### DETAILED DESCRIPTION

According to an embodiment, a video collaboration session is provided in which data corresponding to a collaboration content is processed. The collaboration content includes a video component of a participant relative to a collaboration medium, as well as a medium content component. During the video collaboration session, one or more display characteristics of the video component and/or medium content component are programmatically adjusted based on one or more presentation rules that relate to how the video component is to appear relative to at least the portion of the medium content component.

A collaboration medium refers to any medium on which collaboration content is provided. As an example, a collaboration medium can correspond to an electronic whiteboard, a surface on which computer-generated content is projected, a display screen of a laptop or desktop computer, or a touch screen of a tablet.

An interaction content component refers to content that is generated by a participant of the collaboration session as input, in response to viewing collaboration content during the collaboration session. The interaction content component can be created through use of an interface, such as a touch or contact-sensitive interface, or through an input mechanism such as a pointer device (e.g., mouse) or keypad. An example of interaction content includes electronic ink, which generated by one participant writing or drawing on a contact/touch sensitive collaboration medium or surface.

A medium content component refers to content components that are shared by a participant of a collaboration session. Medium content components can include, for example, a media input (e.g., shared document or presentation), and/or interaction content generated by one participant through input with the collaboration medium. As an example, a medium content component includes whiteboard content or elements, in the context of a collaboration system which uses an electronic whiteboard.

The term “content component” refers to a particular form or type of content that is included as part of the collaboration content. As examples, content components of the collaboration content can include a video component, a medium content component, and/or an interaction content component.

Among other effects, one or more display characteristics can be adjusted to visually enhance, for example, the contrast between the different content components of the collaboration content. For example, display characteristics can be adjusted to enhance an appearance of a video component of a collaboration content, depicting another participant, so that the video component appears as a separate layer from other content components that are provided as part of the same collaboration content (e.g., one or more medium content components, such as provided by shared electronic ink or media). [0012] At least some embodiments described herein reduce visual clutter that would otherwise be present as a result of collaboration content that includes a concurrently presented video component and a medium content component. The reduction of visual clutter can enhance the presentation or viewability of medium content, particularly when video of a participant is superimposed or overlaid with the medium content.

Furthermore, at least some embodiments provide for adjusting the display characteristics of one or more content components of a collaboration content (e.g., video, medium content) in a manner that enhances the viewability of the content as a whole, as compared to, for example, using a constant translucent backdrop (e.g., displaying video) as a media component for the collaboration content, which can occlude or degrade a video component or a media component of the collaboration content.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules. A programmatic module may include a program, a subroutine, a portion of a program, or a software or hardware module capable of performing one or more stated tasks or functions. As used herein, a module can exist on a hardware device or system independently of other modules. Alternatively, a module can be a shared element or process of other modules, programs or machines.

System Description

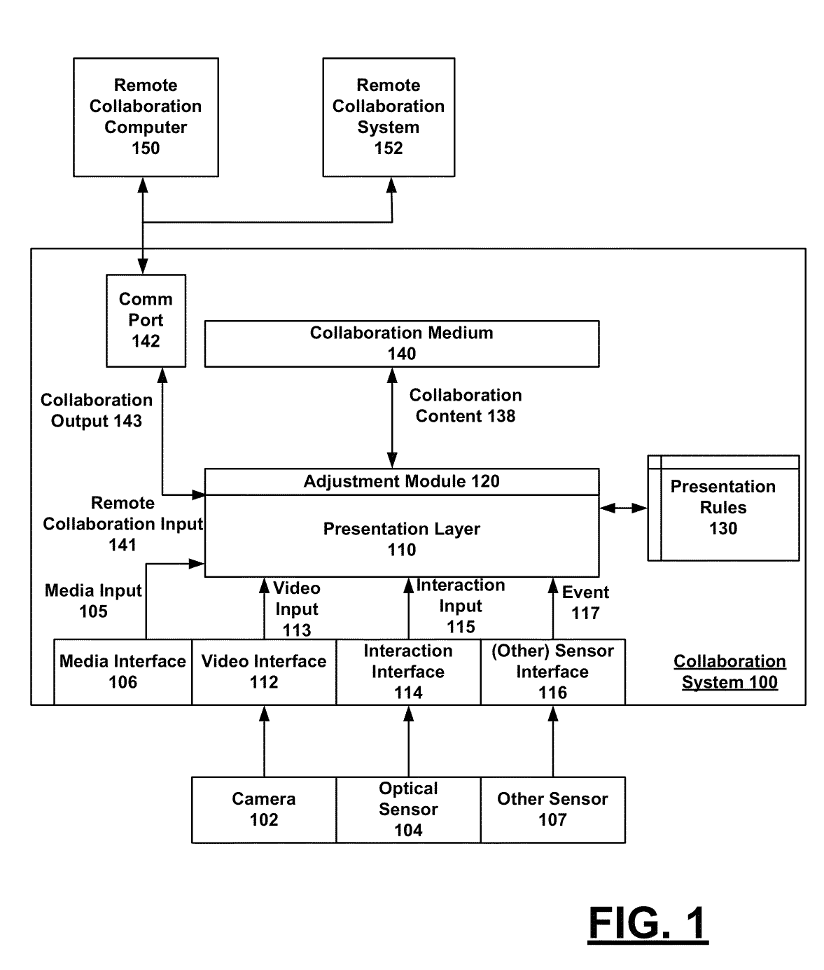

FIG. 1 illustrates an example system for implementing a video collaboration session, according to one or more embodiments. A collaboration system 100 is adapted to capture or receive various inputs for generating collaboration content, and for sharing collaboration content with one or more other collaborating systems. The collaboration system 100 includes a presentation layer 110 that generates collaboration content 138 from a variety of inputs (including inputs for local and remote content components) for rendering or display on a collaboration medium 140. According to embodiments, the collaboration system 100 also includes an adjustment module 120 that utilizes a set of presentation rules 130 to adjust, modify and/or enhance one or more content components that comprise the collaboration content 138.

The collaboration medium 140 can be provided as, for example, an electronic whiteboard. In variations, the collaboration medium 140 can be provided by, for example, a computing device, such as a tablet. The collaboration system 100 can be implemented for a local user that is a participant to a collaboration session, along with one or more other participants who are located remotely. A user of collaboration system 100 can be a presenter, a viewer, or both presenter and viewer.

According to embodiments, the presentation layer 110 provides the collaboration content 138 on the collaboration medium 140 for the local user. The collaboration content 138 can comprise content components, such as a video or medium content received from a remote collaboration source, as well as content components generated from local inputs. For collaboration system 100, an embodiment provides for the collaboration content 138 to include (i) a video component of the remote participant, provided from the video input 113, and (ii) a media component, such as shared documents, provided from the media input 105. Other content components can be generated from local inputs (e.g., medium content components such as provided from surface interactions, electronic ink etc.).

According to embodiments, one or more content components of the collaboration content 138 can be programmatically adjusted in accordance with one or more of the presentation rules 130 that relate to how a portion of one content component of the collaboration content 138 is to appear relative to a portion of another of its content components. For example, one or more presentation rules may determine an adjustment to a display characteristic that relates to how a video component of the collaboration content 138 is to appear relative to other components of the collaboration content 138, such as an interaction content component in the form of electronic ink. The presentation rules 130 can be implemented to enhance the viewability of the collaboration content 138 as a whole.

According to embodiments, collaboration system 100 includes multiple interfaces to receive local inputs. The local inputs can provide some of the content components that comprise the local collaboration content 138, as well as content components that comprise remote collaboration content generated on the remote collaboration site. In an embodiment, collaboration system 100 includes a video interface 112 to receive video input 113 from a camera 102. The video interface 112 can record, for example, the local user, the user's face and/or the collaboration medium 140. A media interface 106 receives media input 105 from, for example, a device or computer. For example, the media interface 106 can include a connector interface, a storage device interface, or a local or wireless communication port which receives the media input 105 from a computer of the local participant. The media input 105 can include a media component that is rendered on the collaboration medium 140, including media that is shared between the collaboration systems. The media input 105 can correspond to, for example, a document, a video clip, a slide deck or presentation, or other content provided by the user.

Additionally, collaboration system 100 includes an interaction interface 114, which can process one or more kinds of interaction input 115 from the local participant (e.g., generation of electronic ink or whiteboarding elements). The interaction interface 114 can include or utilize sensors, such as touch sensitive sensors or optical sensors 104, which can be provided with, for example, the surface of the video capture medium. For example, in implementations when the collaboration medium 140 is provided as an electronic whiteboard or interactive display screen, a surface of the electronic whiteboard may include one or more sensors (e.g., contact-sensitive or touch sensors, optical sensors etc.) to detect user proximity, touch or pen/ink input. Other sensor interfaces 116 can also be used to detect events 117 and/or other forms of inputs from other sensors 107. As described by some embodiments, events such as proximity (as detected by touch or proximity sensors) can be used to trigger implementation of one or more presentation rules 130. As additional examples, contactless interaction from one participant (e.g., user gestures into air) can be utilized, such as provided to the use of depth image sensors.

The inputs received from the various interfaces can be used to generate some or all of the collaboration content 138 provided on the collaboration medium 140. Additionally, the inputs received from one or more of the interfaces can be communicated as collaboration output 143 to another remote collaboration computer 150 or remote collaboration system 152 via the communication port 142. Thus, local inputs corresponding to media input 105, video input 113 and/or interaction input 115 can be communicated to other computers or systems that are participating in a particular collaboration session. Additionally, some or all of the local inputs can be used by the presentation layer 110 to generate collaboration content 138 for the local collaboration medium 140.

The communication port 142 can correspond to, for example, a wireless communication port (e.g., Wireless Fidelity or 802.11(a), (g) or (n), Bluetooth, cellular), local or wide area network port, or other communication link. The presentation layer 110 can be implemented by one or more applications or logic (software, hardware or firmware).

One or more applications and/or other logic of the presentation layer 110 can operate to generate collaboration content 138 from multiple sources. In one implementation, presentation layer 110 concurrently executes programming logic to generate the collaboration content 138 based on some or all of the local inputs on one display screen. Additionally, the presentation layer 110 may integrate remote collaboration input 141 as part of the collaboration content 138. The remote collaboration input 141 can be received from a remote participant to the collaboration session, over the communication port 142. The remote participant may operate remote collaboration computer 150, corresponding to, for example, a computing device, such as a personal computer or tablet. Alternatively, the remote participant can operate a remote collaboration system 152, with modules and functionality similar to collaboration system 100. The remote collaboration input 141 can include, for example, video of the remote collaborator or remote collaborator's face, interaction input (e.g., surface or otherwise) of the remote user, and/or media input of the user.

In some variations, however, the remote collaboration input 141 can be limited or non-existent. For example, the remote collaborator may operate on a computing environment that limits the participant's ability to provide input when viewing collaboration content. As another example, the collaborator may lack video feed. Thus, for example, the remote collaboration input 141 may lack some or all of the components of the local collaboration content 138 as described.

For the local user, the collaboration content 138 can be rendered in part or in whole on the collaboration medium 140. In one implementation, the collaboration medium 140 is provided as an electronic whiteboard, capable of receiving media input, detecting user interaction with a surface (e.g., exterior of the collaboration medium), capturing video, and rendering collaboration content 138. For example, as an electronic whiteboard, the collaboration content 138 can include (i) a video component provided from the remote collaboration input 141 (representing, for example, a face of the remote participant), and (ii) shared content component that is generated locally and/or remotely corresponding to media input and/or surface interaction input. In one implementation, the collaboration content 138 is rendered on the collaboration medium 140 in a manner that simulates a window into the scene of the other collaborator who resides at another location. In variations, the collaboration medium 140 can be provided in the display interface of a personal computer or personal electronic device (e.g., tablet). Accordingly, the collaboration content 138 provided with the collaboration medium 140 of collaboration system 100 includes content components (e.g., video, media input, surface interactions) generated from inputs provided from the collaboration system 100, remote collaboration computer 150, and/or remote collaboration system 152 of the collaboration session.

According to embodiments, collaboration system 100 includes the adjustment module 120, which can be implemented as part of the presentation layer 110, to perform graphic adjustments to the components of the collaboration content 138. In some embodiments, the adjustment module 120 operates to generate effects on one or more of the content components that comprise the collaboration content 138. The content components of the collaboration content 138 that can be adjusted or manipulated include content components that are generated from the inputs of the local interfaces (e.g., video input 113, interaction input 115, media input 105), as well as one or more content components provided from the remote collaboration input 141. In this way, the adjustment module 120 can operate to enhance aspects or content components of the collaboration content 138.

In an embodiment, the adjustment module 120 may utilize presentation rules 130 to determine the manner and timing of the adjustment or manipulation to the collaboration content 138. The presentation rules 130 enable the adjustment module 120 to trigger when graphical adjustments are made to portions of the collaboration content 138. In one implementation, the adjustment module 120 graphically adjusts content components of the collaboration content 138 when the collaboration content 138 is locally rendered. As an addition or variation, the adjustment module 120 can operate to adjust collaboration output 143 provided to the remote collaborator. Thus, under some variations, the adjustment module 120 can perform adjustments for either the participant of collaboration system 100, or the other participant using the remote collaboration computer 150 or remote collaboration system 152.

The presentation rules 130 enable the adjustment module 120 to adjust or manipulate the manner in which the different content components of the collaboration content 138 are presented relative to one another. Furthermore, the adjustment module 120 can implement presentation rules 130 for adjusting collaboration content 138 that is received and rendered at a same collaboration system, and/or received and communicated to another collaboration system.

The adjustment module 120 can implement rules that provide for various kinds of adjustments to be performed on collaboration content 138. The adjustments can enhance the collaboration content by, for example, bringing clarity or focus to content components of the collaboration content 138 at specific times when such focus is warranted.

According to embodiments, the presentation rules 130 implemented by the adjustment module 120 include rules that can govern the manner in which one or more content components (e.g., remote or local video component, media content component (including content from collaborator's surface interaction) of the collaboration content 138 are presented when those content components are overlaid or superimposed on one another as a result of an event in the collaboration environment. For example, the positioning of a presenter in video component can affect the appearance of other content, as the video of the presenter may occlude or obfuscate other content components that are provided as part of the collaboration content 138. These and other considerations are accounted for by implementing adjustments to display characteristics of one or more content components of the collaboration content 138. As an example, the adjustments to the display characteristics can reduce or enhance one or more content components of the collaboration content 138 in order to provide clarity or focus when overlays or superimpositions occur. Other implementations in which one or more display characteristics of collaboration content 138 are adjusted are described with other examples.

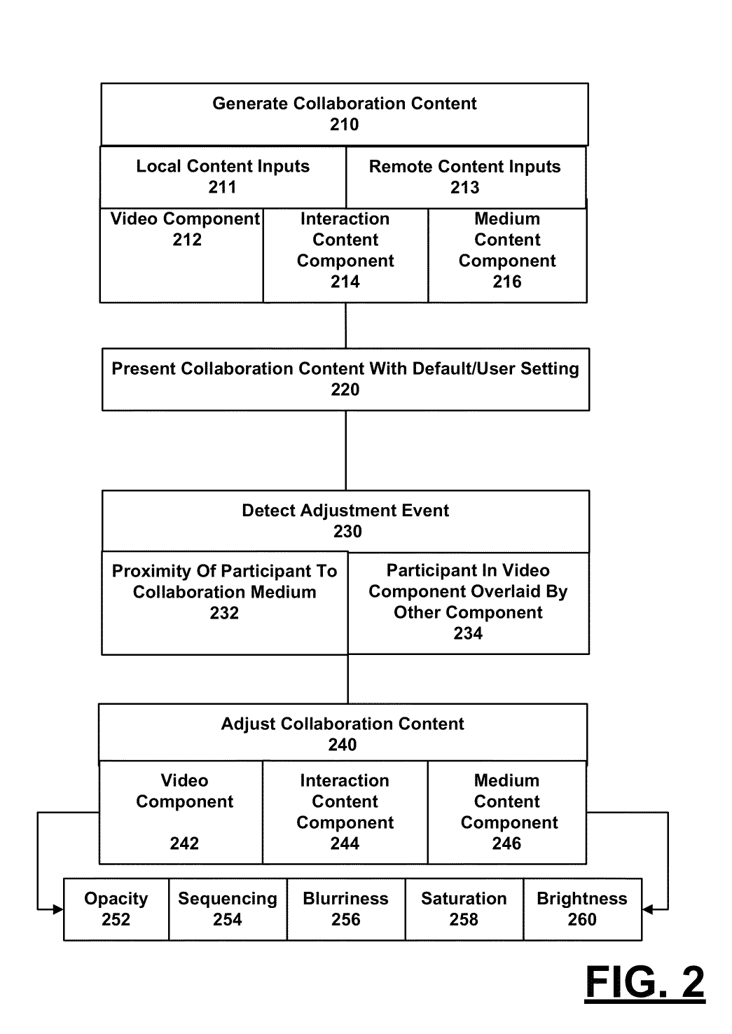

FIG. 2 illustrates an example method for implementing a video collaboration session, according to one or more embodiments. A method such as described by an embodiment of FIG. 2 may be implemented using, for example, a system such as described by an embodiment of FIG. 1. Accordingly, reference may be made to elements of FIG. 1 for purpose of illustrating, for example, suitable modules of a system for performing a step or sub-step being described.

In an embodiment, collaboration content is generated on the collaboration system 100 (210), in connection with an active collaboration session between two or more participants. For collaboration system 100, the collaboration content 138 is generated from (i) local content inputs (211), reflecting collaborative contributions of the user of the collaboration system 100, and (ii) remote content inputs (213), reflecting the collaborative contributions of the remote participant(s) to the particular collaboration session. The local and remote content inputs can be provided through the interfaces of the respective collaboration system 100, remote collaboration computer 150, and/or remote collaboration system 152. As described with an embodiment of FIG. 1, the content components of the collaboration content 138 can include one or more video components (212), including video input 113 from the video interface 112 (local inputs), as well as video provided from the remote participant. On collaboration system 100, the video component can be of the remote user, so that the local user can view the remote user or the remote user's scene (e.g., video of electronic board).

The content components of the collaboration content 138 can also provide for an interaction content component (214) that includes local or remote user interaction during the collaboration session. For example, the interaction content component can include the local user generating ink input on the collaboration medium 140. In one implementation, the ink input corresponds to the local user contacting a surface of the collaboration medium 140 (e.g., user writing on the collaboration medium 140). The remote collaborator can also generate interaction content, such as ink input on a remote collaboration medium. Other forms of interaction content component can be generated from, for example, the user operating an input device, such as a mouse or pointer, keyboard, or other input accessory device.

The collaboration content 138 can also include a medium content component (216), which can be provided from the local or remote participant. For example, the media input component can be provided by one participant specifying a document, image, presentation or video for sharing in the collaboration session. For example, the local user can input a document or other media input 105 using media interface 106. The media input 105 can be communicated by collaboration system 100 to the remote collaboration computer 150 or remote collaboration system 152.

The various content components of the collaboration content 138 can be presented together based on user or default settings (220). The content components can be presented when generated in response to events, such as initiation of the collaboration session and actions of the individual collaborators (e.g., user uploads the media input 105). When present at one time, the content components of the collaboration content 138 can be collectively presented in accordance with user or default settings. For example, the ordering (or sequencing) of individual content components, and/or the opaqueness or translucency of one content component versus another (when multiple components are rendered at one time) can be determined by default or user settings. The default settings can be based on presentation rules 130, such as presentation rules to (i) order video components relative to media or interaction content components on the collaboration medium 140, or (ii) make a portion of one of the content components (e.g., video) translucent when there is overlay between multiple content components of the collaboration content 138 (e.g., make ink translucent overlay on video).

During the collaboration session, one or more adjustment events can be detected which result in the adjustment module 120 adjusting one or more content components of the collaboration content 138 (230). The adjustment to the collaboration content 138 can occur at or near specific regions of the video collaboration content that are relevant to the event. In one embodiment, an adjustment event corresponds to one participant being in proximity to the collaboration medium 140 (232) (e.g., participant contacts or approaches the collaboration medium). As an addition or alternative, the adjustment event can correspond to the video component depicting one participant being overlaid by another component of the collaboration content 138 (234). For example, the adjustment event can correspond to an interaction content component (e.g., as provided from ink or media input) overlaying the face of the participant in the video component. The event can occur at, for example, the site of the remote collaboration system 152, while the response to the event can occur at the local collaboration system 100. Likewise, the event can correspond to the location of the collaboration system 100, and may be communicated and responded to by the remote collaboration system 152.

In response to the event, the collaboration content 138 is adjusted (240). According to embodiments, the adjustment can be made to one or more of the content components of the collaboration content 138, such as to the video component (242) (e.g., video depicting remote user's face), interaction content component (244) or medium content component (246). In one embodiment, the adjustment module 120 of collaboration system 100 can perform the adjustment in response to an event that occurs or is generated at the site of the other participant. As an alternative or adjustment, the adjustment module 120 can perform the adjustment based on an event corresponding to the occurrence of a condition in the collaboration content 138 (e.g., video component is overlaid by another content component).

According to embodiments, the adjustment module 120 graphically adjusts at least a portion of one content component (e.g., video, shared interaction content, media) relative to another. The graphic adjustment can correspond to altering, relative to the initial or default setting, one or more display characteristics corresponding to, for example, opacity (252), ordering (254) or sequencing of the content components, blurriness (256), saturation (258) and/or brightness (260).

In some embodiments, the particular adjustment that is performed is based on the particular event that generates the adjustment response. For example, an event may correspond to the participant of the remote collaboration system 152 walking up to an electronic whiteboard that serves as that system's collaboration medium. In response to the event that occurs with the remote participant, the opacity of the video component provided at the collaboration system 100, as provided by the remote collaboration input 141, is altered. As an alternative or addition, the opacity of interaction content component (e.g., surface interaction content) provided by the remote collaborator standing near the remote collaboration medium can also be changed. For example, in response to the adjustment event, the collaboration content 138 provided on collaboration system 100 can reflect the video of the remote collaborator's face to be more translucent than the default or original setting, and the surface interaction input provided by the remote collaborator contacting the collaboration medium of the remote system can be made darker or more opaque. In such an embodiment, the adjustment module 120 can dynamically adjust the opacity of one or more of the content components of the collaboration content, particularly in a region of the collaboration medium that is relevant to the event.

In some embodiments, different adjustments may be made for different components of the collaboration content 138. For example, an event can result in a portion of the video component being blurred, while another content component (e.g., media input from the remote collaboration system 152) becomes more opaque or bright.

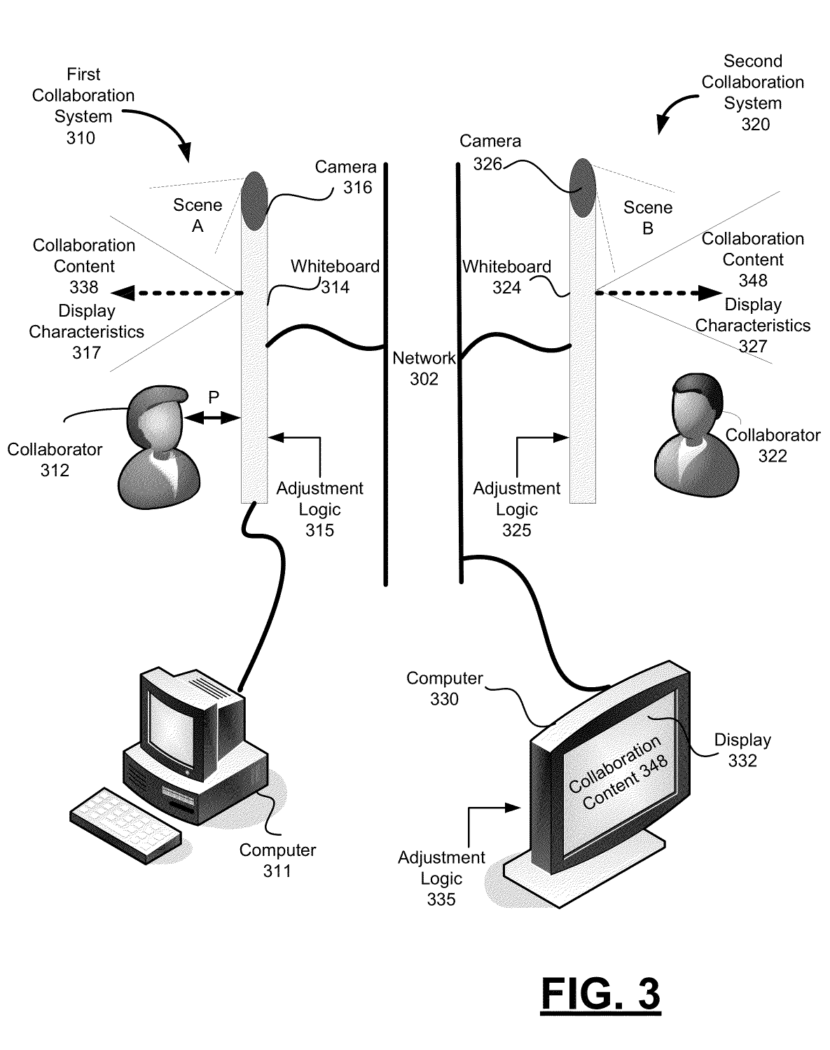

FIG. 3 illustrates an example of a collaboration session, implemented using one or more embodiments such as described with FIG. 1 or FIG. 2. With reference to FIG. 3, a first collaboration system 310 may be used by a collaborator 312 at a first location, and a second collaboration system 320 may be used by a collaborator 322 at a second location. The first collaboration system 310 and the second collaboration system 320 may be communicatively linked across one or more networks 302, such as across the Internet, a wide area network or combination of networks.

In the example provided, each of the first collaboration system 310 and second collaboration system 320 may include an electronic whiteboard 314, 324 that serves as the respective collaboration medium. Each collaborator 312, 322 may approach the respective electronic whiteboard 314, 324 in order to view the respective collaboration content 338, 348. Optionally, each collaborator can share interaction content by contacting or otherwise interacting with interfaces of the respective electronic whiteboard 314, 324 (or other collaboration mediums). For example, electronic whiteboards 314, 324 may be equipped with sensors that detect the user touching the surface of the respective whiteboards. Other sensors may also be included with the whiteboard, such as for example, proximity sensors that detect when a user is near or proximate to the respective whiteboard, light sensors, and/or audio sensors. For example, each participant can interact with the electronic whiteboards 314, 324 by providing a surface interaction, such as electronic ink (e.g., user can operate a pen or finger to generate electronic ink on the respective electronic whiteboards 314, 324).

Each of the first collaboration system 310 and the second collaboration system 320 may also include a respective camera 316, 326 to record a scene at the location of the system. In some implementations, the cameras 316, 326 are directed outwards from the electronic whiteboards 314, 324, so as to record the faces of the participants. The video recorded at the first collaboration system 310 is communicated to the other collaboration system. Thus, in the example provided, the participant of first collaboration system 310 can view the electronic whiteboards 314 to view collaboration content that includes video of the collaborator 322 of the second collaboration system 320.

In addition, each collaborator 312, 322 can provide media input using, for example, computer 311 (shown with the first collaboration system 310). Thus, as an example, the participant of the first collaboration system 310 can view collaboration content that includes a video component of the scene (B) of the collaborator at the second collaboration system 320, as well as medium content components (e.g., media that one or both users provided on their respective electronic whiteboards 314, 324) or interaction content components (e.g., electronic ink provided by the collaborators).

In embodiments, each of the first collaboration system 310 and the second collaboration system 320 is configured to dynamically adjust one or more display characteristics 317, 327 of the collaboration content 338, 348 provided on the respective electronic whiteboards 314, 324. The dynamic adjustment to the display characteristics 317, 327 can be made on one or both of the first collaboration system 310 or the second collaboration system 320, independent of any adjustments (or non-adjustments) made on the other of the first or second collaboration systems 310, 320.

In an embodiment, each of the first collaboration system 310 and the second collaboration system 320 includes or implements adjustment logic 315, 325 to dynamically adjust display characteristics 317, 327 of content components of the respective collaboration content 338, 348, in response to events or conditions that occur during a particular collaboration session. For example, an embodiment provides that adjustment logic 315 of the first collaboration system 310 is triggered by an event that corresponds to the collaborator 322 of the second collaboration system 320 approaching the electronic whiteboard 324 so as to make contact and/or provide interaction content. In a variation, the adjustment event can correspond to the collaborator 312 of the first collaboration system 310 making contact with the electronic whiteboard 314 in a manner that results in the generation of an interaction content component, such as electronic ink generated on the electronic whiteboards 314. In variations, the response to the event can occur at either the location of the first collaboration system 310 where the event occurred, or at the location of the other collaboration response. For example, in response to the event where the collaborator 312 approaches the electronic whiteboard 314 within distance P, the collaboration content appearing on the electronic whiteboard 324 can be adjusted. For example, one or more display characteristics 327 of the content components that comprise the collaboration content 348 appearing on the electronic whiteboard 324 can be adjusted. In one embodiment, the display characteristics 317, 327 that can be adjusted by the respective adjustment logic 315, 325 include opacity and/or translucency. For example, the response to the collaborator 312 approaching the electronic whiteboard 314 can be that the (i) video component of the collaboration content appearing on the electronic whiteboard 324 can be made more translucent (e.g., as compared to an original or default setting), and/or (ii) the opacity of other content components of the collaboration content, such as media or electronic ink, can be increased (e.g., darkened). Other types of display characteristics 317, 327, such as sequencing (or ordering), blurriness, saturation and/or brightness can also be adjusted, using adjustment logic 315.

In variations, the event that triggers the adjustment can correspond to conditions that occur in the collaboration content as presented on one of the electronic whiteboards 314, 324. For example, if the video component of the collaboration content appearing on the electronic whiteboard 314 (e.g., video of the face of the collaborator 322) overlaps with other content components of the collaboration content, such as an interaction content component (e.g., electronic ink), a condition may be met in which one of the components (e.g., video of face of collaborator 322) is altered. For example, the portion of the video component depicting the face of the collaborator 322 may be made more opaque or blurred.

In variations, other types of events can be detected and responded to. For example, events that can be detected can include (i) a participant of the collaboration system moving a distance away from the electronic whiteboard, and/or (ii) the presence of a particular type of media in the collaboration content (e.g., document versus uploaded image).

In an alternative implementation to the examples discussed, collaborator 322 can utilize a computer 330 as a collaboration system. The computer 330 may present collaboration content 348 on a display screen 332. Alternatively, a third collaborator may operate computer 330 as a collaboration system (in addition to collaborators 312, 322 on respective first or second collaboration systems 310, 320). For the collaborator on computer 330, the components of the collaboration content 348 can be implemented through adjustment logic 335 (e.g., programming). As described with examples provided, the adjustment logic 335 can adjust one or more display characteristics of collaboration content 348, which can include video (e.g., of collaborator 312 on first collaboration system 310) and other content components. Some or all of the other content components can be generated on the computer 330.

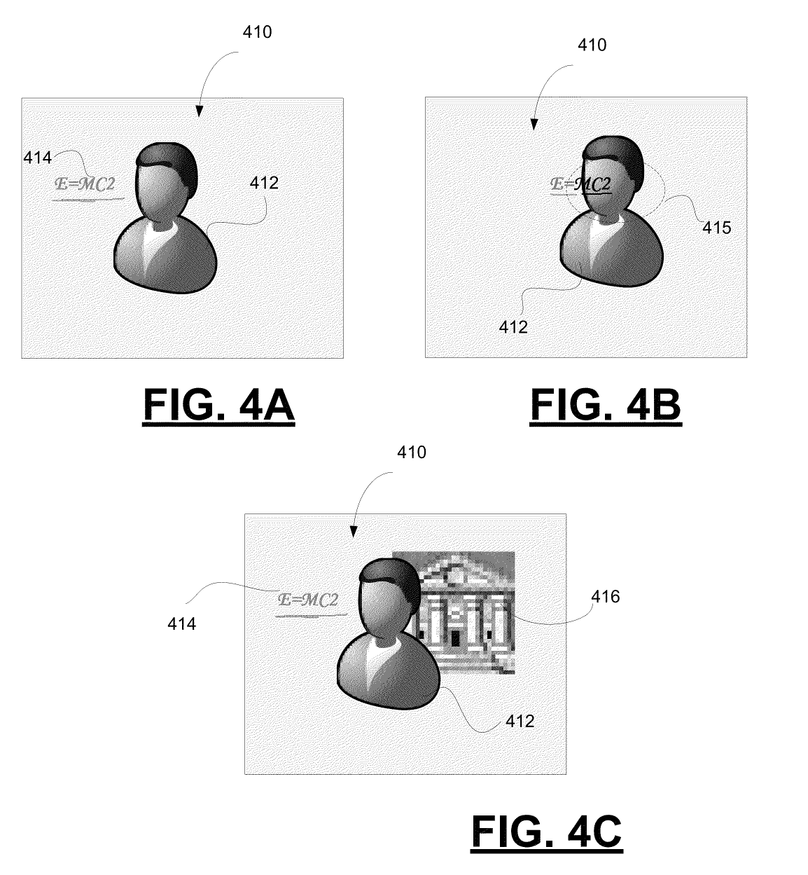

FIG. 4A through FIG. 4C illustrate examples of dynamic adjustments that can be made to the display characteristics of collaboration content, according to one or more embodiments. With reference to FIG. 4A, a collaboration content 410 can include a video component 412 and an interaction content component 414 (e.g., electronic ink provided by a user of the collaboration system). In one embodiment, the video component 412 displays the face or front of another collaborator (e.g., via remote collaboration input 141, see FIG. 1). For example, the video component of the other collaborator can display a face or front of the other collaborator. In the example provided, each of the video component 412 and interaction content component 414 can have a default or user determined setting for display characteristics such as opacity. For example, the video component 412 may be darkened, while the interaction content component 414 can be lightened or partially translucent.

With regard to FIG. 4B, the occurrence of an event can correspond to the depicted collaborator nearing a surface of that user's collaboration medium. For the other collaborator viewing the event, the result is that the interaction content component 414 is more difficult to see. In order to adjust for this lack of distinction, an embodiment provides for at least a portion 415 of the interaction content component to be darkened, or made more opaque (relative to a default or original setting). As an addition or variations, a portion of the video component 412 can be made more opaque relative to, for example, a default or original setting.

FIG. 4C illustrates an additional or alternative feature in which the display characteristics include making adjustments that also vary the ordering of the different components that comprise the collaboration content. For example, collaboration content 410 can include the video component 412, the interaction content component 414, and a medium content component 416 (e.g., image provided by a user). In an embodiment, a triggering condition may correspond to when at least two of the components overlay when presented as part of the collaboration content 410. In response to the occurrence of the condition, one or more embodiments provide for an adjustment in which, for example, the video component 412 (or portion depicting the other collaborator) is brought to the forefront. Other components, such as the medium content component 416 can be moved to the background. The interaction content component 414 can, for example, be provided as an overlay to the video component 412.

In one embodiment, when the local user interacts with the collaboration medium 140, the display characteristics are adjusted so as to render a translucent backdrop selectively in regions near the local users interaction with the collaboration medium. The implementation of the display characteristics may be provided for either the remote or local collaborator. If the collaboration system 100 supports proximity sensing (or hovering), the translucent backdrop can be rendered prior to the user touching the collaboration medium 140. In variations, the translucent backdrop can be adjusted in size (e.g., grown) to cover areas of user interaction.

The various responses to events and conditions depicted with the collaboration content 410 can be based on the presentation rules 130. Various presentation rules may be selected or implemented to dynamically adjust display characteristics of one or more components of the collaboration content 410. The implementation of presentation rules 130 may be triggered by defined events or conditions, such as described by examples provided herein.

Hardware Diagram

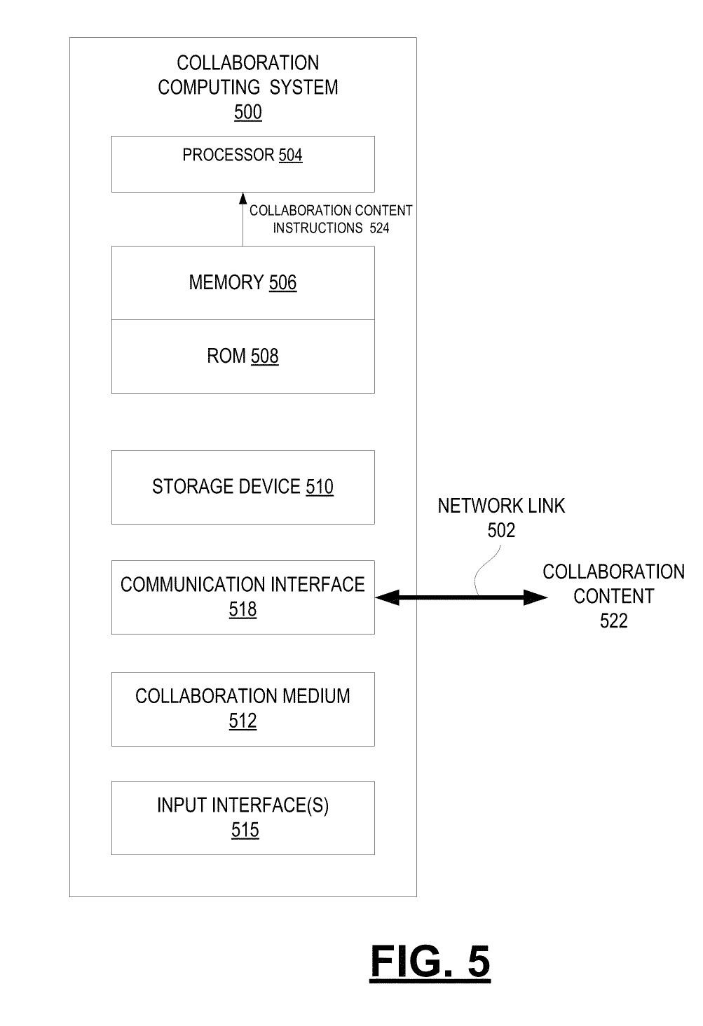

FIG. 5 illustrates an example computing system which can be implemented with or as part of a collaboration system, according to one or more embodiments. In an embodiment, collaboration computing system 500 includes processor 504, memory 506, ROM 508, storage device 510, and communication interface 518. The collaboration computing system 500 includes at least one processor 504 for processing information. The collaboration computing system 500 also includes a memory 506, such as a random access memory (RAM) or other dynamic storage device, for storing information and instructions to be executed by processor 504. Memory 506 also may be used for storing temporary variables or other intermediate information during execution of instructions to be executed by processor 504. collaboration computing system 500 may also include a read only memory (ROM) 508 or other static storage device for storing static information and instructions for processor 504. A storage device 510, such as a magnetic disk or optical disk, is provided for storing information and instructions.

The communication interface 518 may enable the collaboration computing system 500 to communicate with one or more networks through use of the network link 502. As described with some embodiments, the communication interface 518 can be used to receive remote collaboration input 141 (see FIG. 1) from other collaboration systems. Additionally, the communication interface 518 can be used to signal collaboration output 143 (see FIG. 1) to another collaboration system.

The collaboration computing system 500 can include or interface with a collaboration medium 512 (e.g., touch-sensitive display, electronic whiteboard). One or more input interfaces 515 can be integrated or provided with the collaboration medium 512. Examples of input interfaces 515 include touch-sensors (or other contact sensors) to detect, for example, a user generating interaction content such as electronic ink. Other examples of input interfaces 515 include a mouse or input device (e.g., keyboard) which the user can utilize to create, for example, interaction content. While only one input interface 515 is depicted in FIG. 5, embodiments may include any number of input interfaces 515 coupled to collaboration computing system 500.

Embodiments described herein are related to the use of collaboration computing system 500 for implementing the techniques described herein. According to one embodiment, those techniques are performed by collaboration computing system 500 in response to processor 504 executing one or more sequences of one or more instructions contained in memory 506. Such instructions may be read into memory 506 from another machine-readable medium, such as storage device 510. Execution of the sequences of instructions contained in memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

In particular, memory 506 can store collaboration content instructions 524, accessible to the processor 504, including instructions to dynamically adjust display characteristics of components of a collaboration content. The processor 504 can cause collaboration content to be rendered on the collaboration medium 512, using inputs as received from the input interfaces 515 and from the remote collaborators over network link 502. The processor 504 executes instructions to dynamically adjust one or more display characteristics of components that comprise the collaboration content. At least some collaboration content 524 can also be communicated from the collaboration computing system 500 using the communication interface 518.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for presenting collaboration content for a video collaboration session, the method being implemented by one or more processors and comprising:
processing data corresponding to the collaboration content, the collaboration content including (i) a video component of a participant relative to a collaboration medium, and (ii) a medium content component; and
during the video collaboration session, programmatically adjusting one or more display characteristics of at least one of the video component or at least a portion of the medium content component based on one or more presentation rules relating to how the video component is to appear relative to at least the portion of the medium content component when superimposition exists as between the video component and the medium content component.

2. The method of claim 1, wherein the medium content component is based on at least one or both of a media input for the collaboration medium or an interaction input of the participant with the collaboration medium.

3. The method of claim 1, wherein the one or more display characteristics include an opacity, a blurriness, a sequencing, a saturation, and/or a brightness.

4. The method of claim 1, wherein the one or more presentation rules provide for automatically adjusting the one or more display characteristics, for a portion of the video component that corresponds to a region of the collaboration medium, in response to the participant contacting that region of the collaboration medium.

5. The method of claim 1, wherein the one or more presentation rules provide for automatically adjusting the one or more display characteristics when the participant appears, to a viewer of the collaboration content, to be in front of or behind the portion of the medium content component.

6. The method of claim 1, wherein the medium content component is based on a surface interaction of the participant with the collaboration medium, and wherein programmatically adjusting includes adjusting an opacity of a portion of the medium content component corresponding to the surface interaction based on a presence of the participant near a location of the surface interaction.

7. A system providing a video collaboration session, the system comprising:
a collaboration medium to receive media;
a camera to capture a video of a participant interacting with the collaboration medium; and
one or more processors to generate, during the video collaboration session, a collaboration content that includes a video component for the video, and a medium content component for the media; the one or more processors generating the collaboration content by adjusting one or more display characteristics of at least one of the video component or at least a portion of the medium content component based on one or more presentation rules relating to how the video component is to appear relative to at least the portion of the medium content component when superimposition exists as between the video component and the medium content component.

8. The system of claim 7, wherein the collaboration medium receives media representing a surface interaction between the participant and the collaboration medium.

9. The system of claim 8, wherein the collaboration medium including a sensor interface to capture the surface interaction.

10. The system of claim 7, wherein the one or more processors include one or more client computers that are connected to the collaboration medium over a network.

11. The system of claim 7, wherein the camera is positioned to have a perspective that is in front of the participant when the participant interacts with the collaboration medium.

12. The system of claim 7, wherein the one or more display characteristics include an opacity, a blurriness, a sequencing, a saturation, and/or a brightness.

13. The system of claim 7, further comprising a memory to store a set of presentation rules, including the one or more presentation rules to automatically adjust the one or more display characteristics, for a portion of the video component that corresponds to a region of the collaboration medium, in response to the participant contacting that region of the collaboration medium.

14. The system of claim 7, further comprising a memory to store a set of presentation rules, including the one or more presentation rules to automatically adjust the one or more display characteristics when the video component of the participant appears, to a viewer of the collaboration content, to be in front of or behind the portion of the medium content component.

15. A non-transitory computer readable medium that stores instructions that, when executed by one or more processors, cause the one or more processors to perform operations comprising:
processing data corresponding to a collaboration content for a video collaboration session, the collaboration content including (i) a video component of a participant relative to a collaboration medium, and (ii) a medium content component; and
providing, during the video collaboration session, the collaboration content, including programmatically adjusting one or more display characteristics of at least one of the video component or at least a portion of the medium content component based on one or more presentation rules relating to how the video component is to appear relative to at least the portion of the medium content component when superimposition exists as between the video component and the medium content component.
